(19) United States
(12) Patent Application Publication
(10) Pub. No.: US 2011/0174168 A1
(43) Pub. Date: Jul. 21, 2011

(54) Dough Pump and Developer

(75) Inventor: Bruce V. Campbell, Richmond, VA (US)

(73) Assignee: AMF Automation Technologies, LLC d/b/a AMF Bakery Systems, Richmond, VA (US)

(21) Appl. No.: 13/007,198

(22) Filed: Jan. 14, 2011

Related U.S. Application Data
(60) Provisional application No. 61/296,910, filed on Jan. 21, 2010.

(51) Int. Cl. A23P 1/00

(52) U.S. Cl. 99/485

(57) ABSTRACT

Dough pump 12 includes an auger 22 that moves oncoming dough from the upwardly facing entry opening 19 of the cylindrical housing 24 and expels the dough laterally from a side delivery conduit 26. A developer 14 includes a laterally facing entry conduit 40 aligned with the side delivery conduit 26 of the dough pump. Developer paddle 48 gently moves the dough along the developer housing 44 to a downwardly facing delivery conduit 46. The dough pump motor 30 and the developer motor 50 are located on opposite ends of their respective housings. The dough pump auger 22 pushes the dough away from the motor and its transmission and toward the side delivery conduit 26. Likewise, the developer paddle 48 moves the dough in the opposite direction away from the motor and its transmission so that the seals at the inlet end portions of the dough pump and developer are less likely to be over-pressurized and are less likely to leak.

### CROSS REFERENCE

This application claims the benefit of U.S. Provisional Application 61/296,910, filed in the U.S. Patent and Trademark Office on Jan. 21, 2010.

### FIELD OF THE INVENTION

This invention concerns the processing of baker's dough and products of similar qualities which is received in a batch from a dough mixer and which is to be transported in a continuous stream to, for example, a dough distribution manifold for subdividing the dough into multiple streams of dough, and subsequently to a dough divider that forms the separate streams of dough into dough balls for further processing and baking. More particularly, this invention concerns a dough pump and a dough developer arranged in series that transport and develop the dough between the mixer and the divider.

### BRIEF DESCRIPTION OF THE DRAWINGS

FIG. 1 is a perspective view of the dough pump and developer and their related components.

FIG. 2 is a front elevational view thereof.

FIG. 3 is a side elevational view thereof.

FIG. 4 shows the dough pump and the developer in side-by-side relationship, with the outlet of the dough pump aligned with the inlet of the developer.

FIG. 5 is an expanded perspective view of the dough pump.

FIG. 6 is an expanded perspective view of the developer.

### DETAILED DESCRIPTION

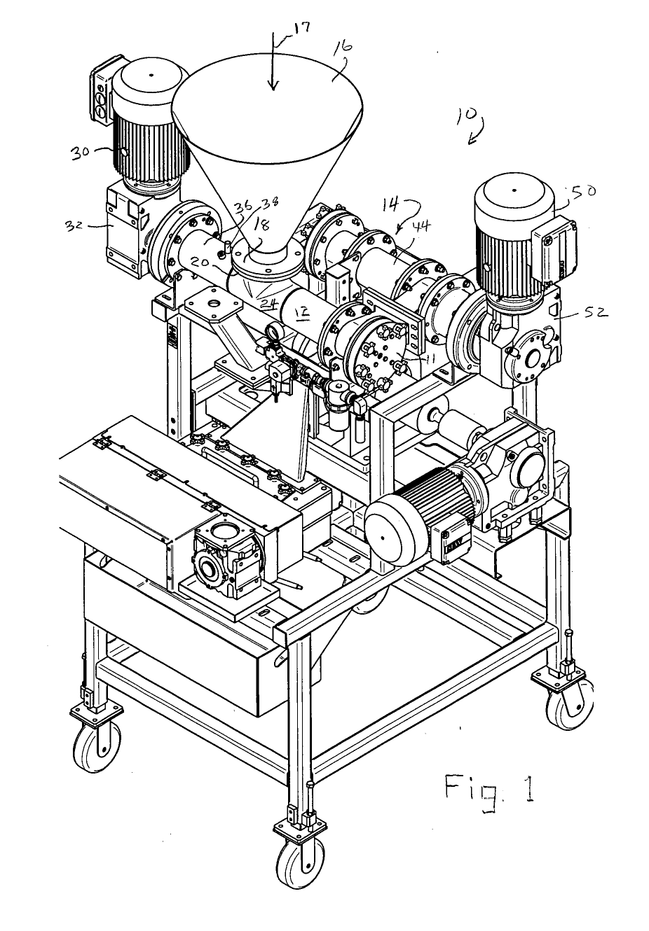

Referring now in more detail to the drawings, in which like numerals indicate like parts throughout the views, FIG. 1 illustrates the combination dough pump and developer 10 that includes a dough pump 12 and a developer 14 mounted on a suitable frame. Both the dough pump and developer are elongated and may be oriented parallel to each other.

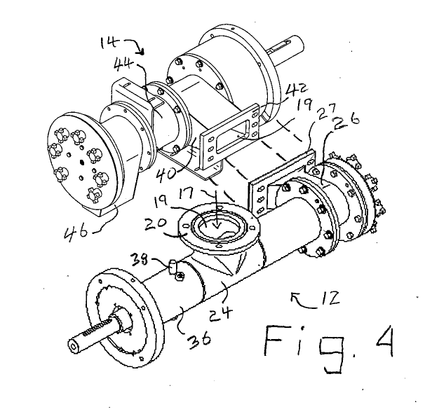

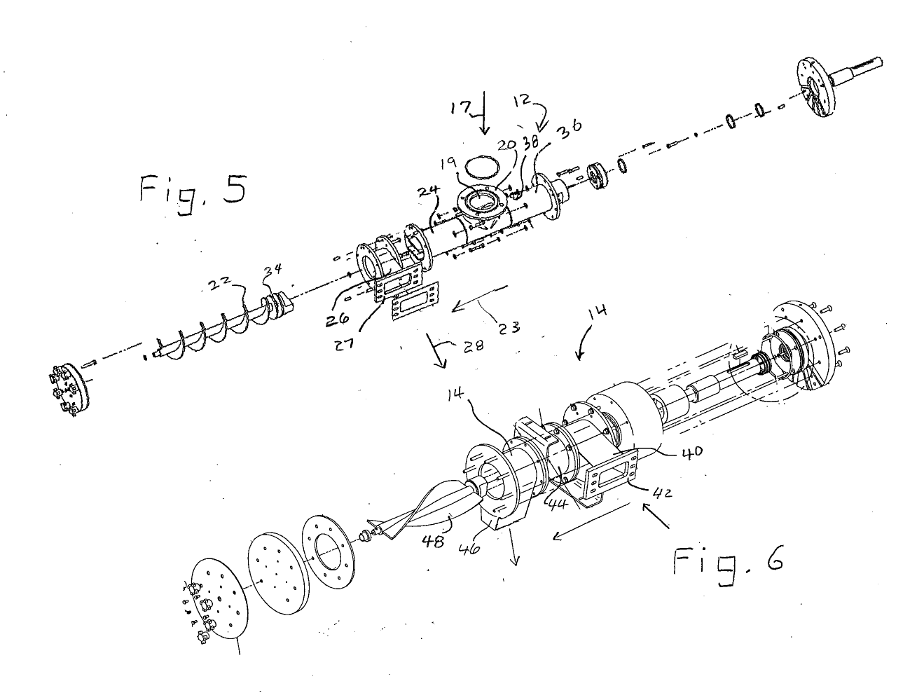

A hopper 16 is mounted over the dough pump 12 and receives dough from a mixer (not shown) and delivers dough to the entrance of the cylindrical housing 24 of the dough pump 12 as indicated by arrow 17. The hopper includes a lower flange 18 that is mounted to the entrance flange 20 of the entry opening 19 (FIG. 4) at the top of the dough pump. An auger 22 (FIG. 5) is located within the cylindrical housing 24 of the dough pump and moves the dough along the length of the housing as indicated by arrow 23 (FIG. 5) to a side delivery conduit 26 of the housing. This permits the dough passing through the dough pump to move laterally from the dough pump cylindrical housing 24 as shown by arrow 28.

Dough pump motor 30 (FIG. 1) is connected through transmission 32 to auger 22, and rotates the auger 22 for moving dough in the vertical, longitudinal and lateral directions indicated by arrows 17, 23 and 28 from the entrance 19 of the dough pump 12 along the length of the cylindrical housing 24, to the side delivery conduit 26, where the dough is expelled under pressure to the developer 14.

As shown in FIG. 5, the smaller auger threads 34 are positioned up stream of the entry opening 19 of the dough pump 12 and are closely spaced. A vacuum conduit 38 communicates through the outside to the inside of the dough pump housing 24 up stream of the vacuum end 26 of the dough pump housing, and the vacuum conduit 38 is connected to a vacuum pump (not shown) for the purpose of drawing a vacuum at the entrance of the dough pump housing, thereby tending to expel gas from the dough being passed from the hopper 16 into the dough pump housing 24.

The auger 22 of dough pump 12 moves the dough under pressure on through the dough pump housing and then through the side delivery conduit 26.

As best shown in FIGS. 4 and 6, developer 14 includes an entry conduit 40 with a connector flange 42 that connects to the delivery conduit connector flange 27 of dough pump 12. Developer 14 includes developer housing 44 that defines a cylindrical interior and a downwardly facing delivery conduit 46.

As shown in FIG. 6, a developer paddle 48 is positioned in the cylindrical interior of the developer housing 44, extending in communication with both the entry conduit 40 and the delivery conduit 46. The developer paddle 48 has a helical configuration that is to gently move and stir the dough passing through the developer 14, in the known manner.

As shown in FIG. 1, the developer paddle is driven by motor 50 through a suitable transmission 52.

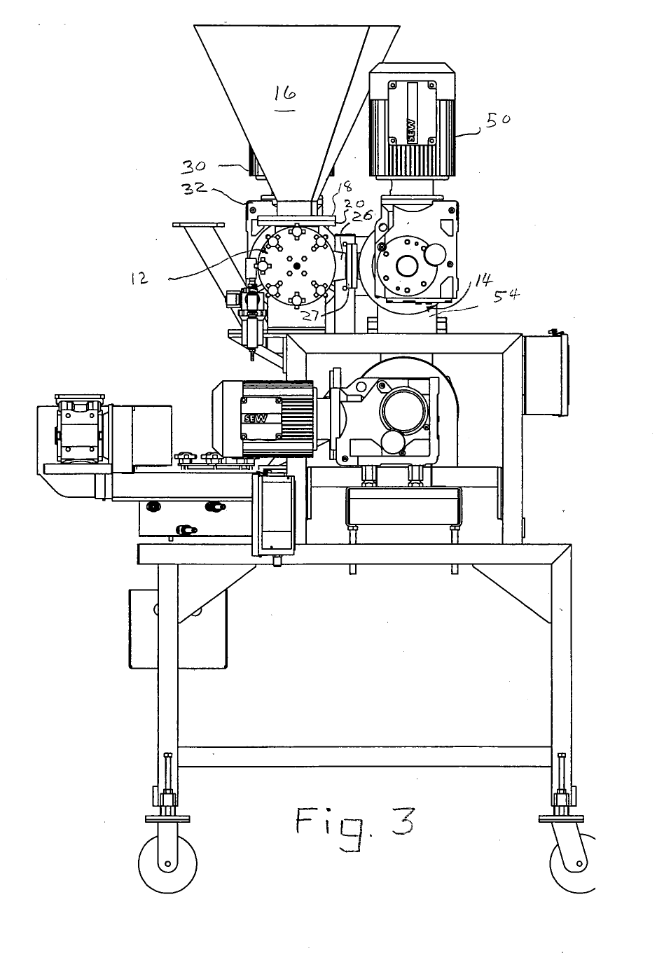

A delivery conduit 54 shown in FIG. 3 connects to the downwardly facing opening of the delivery conduit 46 of the developer, transmitting the developed dough to a dough divider (not shown) that is to divide the larger stream of dough into parallel paths and then cut short lengths of dough from each of the paths of dough, dropping the small dough pieces to, for example, rounder bars where the dough is rounded into an appropriate shape, and then the dough is carried through an oven.

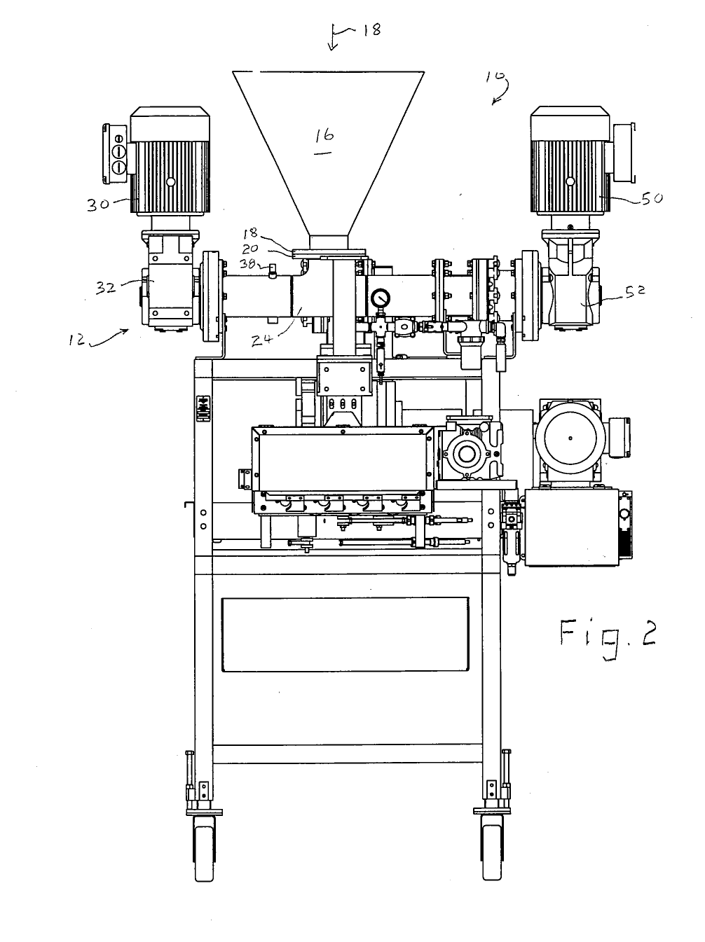

As shown in FIGS. 1 and 2, the motors 30 and 50 for the dough pump and developer, respectively, are located on opposite ends of their respective dough pump and developer. This arrangement assures that the auger 48 in the dough pump cylindrical housing 24 will function to push the dough away from the motor, its transmission and the connection between the transmission and the dough pump cylindrical housing toward the side delivery conduit 26.

Likewise, the motor 50 and its transmission 52 for the developer 14 are positioned at the inlet end of the developer housing 44. Again, this arrangement assures that the movement of the dough as enhanced by the developer paddle 48 moves away from the motor 50 and its transmission 52 so that the seals at the inlet end portion of the developer housing will not leak.

Also, if it is decided that the dough processing system does not require a developer, the developer can be omitted from the processing line, by simply withdrawing the developer paddle 48 (FIG. 6) from its housing 44, allowing the dough to be moved through the developer housing without further turbulence. In the alternative, other components of the developer, or either the entire developer, may be removed from the processing line, with a substitute conduit (not shown) being attached to the delivery conduit connector flange 27 of the dough pump 12, leading to the downstream dough divider and subsequent components of the system.

1. A dough processing apparatus comprising:
a dough pump including an elongated dough pump housing defining an upwardly facing entry opening and a laterally facing side delivery opening spaced along the length of said housing from said upwardly facing entry opening,
an auger positioned in said elongated housing and extending between said upwardly facing entry opening and said laterally facing side delivery opening and configured for moving dough from said upwardly facing entry opening through said elongated housing and out of said laterally facing side delivery conduit,
a dough pump motor in driving relationship with said auger at said upwardly facing entry opening and configured for moving the dough away from said dough pump motor,
a dough developer including an elongated developer housing defining a laterally facing side entry opening aligned with said laterally facing side delivery conduit for receiving dough from said dough pump and a downwardly facing delivery conduit,
a developer paddle positioned in said developer housing for moving dough from said laterally facing side entry conduit through said downwardly facing delivery conduit, and
a developer motor in driving relationship with said developer paddle and arranged to move dough away from said developer motor.

2. The dough processing apparatus of claim 1, wherein said dough pump housing includes a vacuum conduit for directing air away from the dough in the dough pump housing.

3. The dough processing apparatus of claim 1, wherein said dough pump motor and said developer motor are at opposite ends of said dough processing apparatus.
